(19) United States
(12) Patent Application Publication
(10) Pub. No.: US 2016/0046431 A1
(43) Pub. Date: Feb. 18, 2016

(54) Cargo Strap Storing and Dispensing Device

(71) Applicant: Jim Clater, Cecilia, KY (US)

(72) Inventor: Jim Clater, Cecilia, KY (US)

(21) Appl. No.: 14/813,933

(22) Filed: Jul. 30, 2015

Related U.S. Application Data
(60) Provisional application No. 62/036,188, filed on Aug. 12, 2014.

(51) Int. Cl. B65D 83/00; B60P 7/08

(52) U.S. Cl. CPC B65D 83/0038; B60P 7/0846

(57) ABSTRACT

A cargo strap storing and dispensing device for containing and organizing cargo straps in a central location. The cargo strap storing and dispensing device includes a cylindrical container having a base, a sidewall, and an open upper end, defining an interior volume, wherein the upper end is able to receive one or more rolled cargo straps therein. A spring-loaded plunger is disposed within the container and includes a plate that is movable between the upper end and the base of the container. The plate is able to receive the cargo straps thereon and the spring expands and compresses in order to dispense or store the straps. The device further includes a lever having a first end adjustably secured to the plate and a second end disposed through a zig zag cutout in the container, wherein a user can manipulate the lever in order to move the plunger within the container.

### CROSS REFERENCE TO RELATED APPLICATION

This application claims the benefit of U.S. Provisional Application No. 62/036,188 filed on Aug. 12, 2014. The above identified patent application is herein incorporated by reference in its entirety to provide continuity of disclosure.

### BACKGROUND OF THE INVENTION

### Field of the Invention

The present invention relates to cargo strap storing and dispensing devices. More specifically, the present invention provides a cargo strap storing and dispensing device comprising an elongated, cylindrical container having a spring-loaded plunger disposed therein, wherein the container is adapted to receive one or more cargo straps in a rolled configuration therein and the spring-loaded plunger is able to push the rolled cargo straps towards an open end of the elongated container for convenient removal therefrom.

Many individuals that transport large equipment and materials must fasten the load securely to a vehicle, such as a tractor trailer or truck bed. In order to secure such equipment, cargo straps are needed to fasten the load to the vehicle to ensure the load does not fall off the vehicle during transport. However, once cargo straps become unraveled, they are often stored in a pile or in an unorganized manner until needed once again. Unfortunately, it is easy for the elongated straps to become entangled with one another if not properly stored and it is time consuming to separate the entangled straps from one another. Furthermore, even if an individual cargo strap is rolled into an organized configuration, there is not a central location allotted to store the straps, wherein the straps can then be easily dispensed from that central location. Therefore, there exists a need in the prior art for a storage device in which rolled cargo straps can be inserted and easily dispensed for convenient transportation thereof.

Devices have been disclosed in the prior art that relate to cargo strap storing and dispensing devices. These include devices that have been patented and published in patent application publications. These devices generally relate to tubular storage containers adapted to receive rolled sheets therein, such as U.S. Pat. No. 4,986,431, U.S. Pat. No. 4,505,424, U.S. Pat. No. 4,467,917, U.S. Pat. No. 2,738,121, and U.S. Pat. No. 5,275,282.

These prior art devices have several known drawbacks. The devices in the prior art fail to provide an elongated, cylindrical container comprising a spring-loaded plunger disposed on the interior thereof, wherein rolled cargo straps can be inserted into the container and dispensed therefrom via the spring-loaded plunger. The devices disclose containers adapted to receive articles therein, however, the containers fail to provide a spring mechanism adapted to dispense the article therefrom. Thus, the prior art failed to disclose a cargo strap storing and dispensing device that can receive cargo straps therein and easily dispense the straps therefrom.

In light of the devices disclosed in the prior art, it is submitted that the present invention substantially diverges in design elements from the prior art and consequently it is clear that there is a need in the art for an improvement to existing cargo strap storing and dispensing devices. In this regard the instant invention substantially fulfills these needs.

### SUMMARY OF THE INVENTION

In view of the foregoing disadvantages inherent in the known types of cargo strap storing and dispensing devices now present in the prior art, the present invention provides a new cargo strap storing and dispensing device wherein the same can be utilized for providing convenience for the user when organizing, storing, and dispensing cargo straps.

It is therefore an object of the present invention to provide a new and improved cargo strap storing and dispensing device that has all of the advantages of the prior art and none of the disadvantages.

It is another object of the present invention to provide a cargo strap storing and dispensing device comprising an elongated, cylindrical container having a base, a sidewall, and an open upper end, defining an interior volume, wherein the container is adapted to receive one or more cargo straps in a rolled configuration therein.

Another object of the present invention is to provide a cargo strap storing and dispensing device further comprising a spring-loaded plunger having a plate and a spring, wherein the plate rests on the spring and is able to receive the cargo straps thereon, wherein the spring is secured to the base of the container and adapted to move the plate towards the open upper end thereof.

Yet another object of the present invention is to provide a cargo strap storing and dispensing device further comprises a lever having a first end secured to the plate and a second end disposed through a cutout in the container, wherein the lever is adapted to move the spring-loaded plunger towards the open upper end of the container.

Yet another object of the present invention is to provide a cargo strap storing and dispensing device wherein the cutout comprises a plurality of catches in order to control the expansion of the spring.

Another object of the present invention is to provide a cargo strap storing and dispensing device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the cargo strap storing and dispensing device.

FIG. 2 shows a cross sectional view of an embodiment of the cargo strap storing and dispensing device.

FIG. 3 shows a perspective of the second side of the plate of the cargo strap storing and dispensing device.

FIG. 4 shows a cross sectional view of the cargo strap storing and dispensing device.

FIG. 5 shows a perspective view of an embodiment of the cargo strap storing and dispensing device wherein the elongated container is secured to a vehicle.

### DETAILED DESCRIPTION OF THE INVENTION

Reference is made herein to the attached drawings. Like reference numerals are used throughout the drawings to depict like or similar elements of the cargo strap storing and dispensing device. For the purposes of presenting a brief and clear description of the present invention, the preferred embodiment will be discussed as used for organizing, storing, and dispensing cargo straps. The figures are intended for representative purposes only and should not be considered to be limiting in any respect.

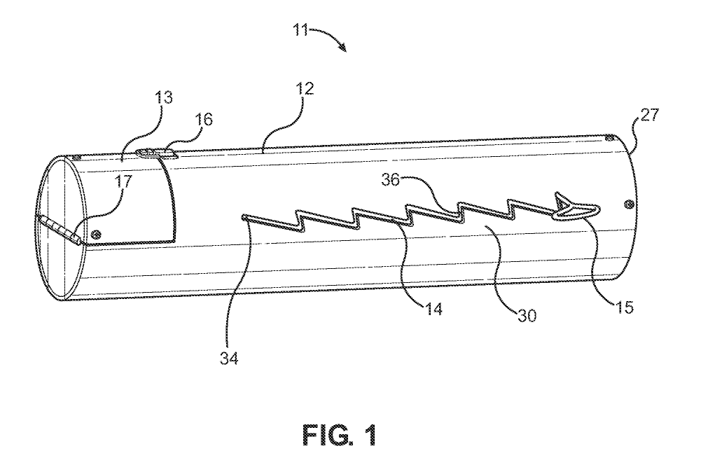

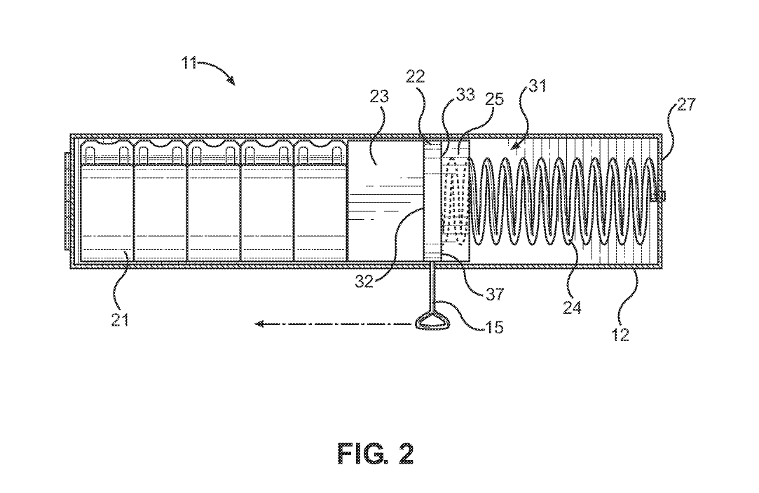

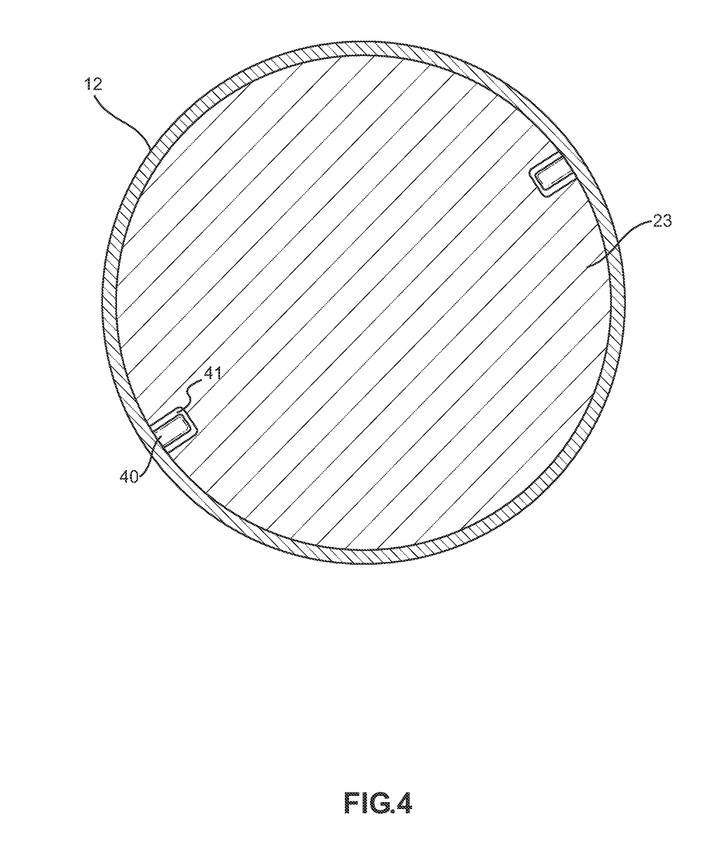

Referring now to FIGS. 1 and 2, there is shown a perspective view of an embodiment of the cargo strap storing and dispensing device and a cross sectional view of an embodiment of the cargo strap storing and dispensing device, respectively. The cargo strap storing and dispensing device 11 comprises an elongated container 12 having a base 27, a sidewall 30, and an open upper end (referenced in FIG. 4, 26), defining an interior volume. Preferably, the container 12 comprises a cylindrical shape in order to receive one or more cargo straps 21 in a rolled configuration therein. The lateral sides of the rolled cargo straps 21 are adapted to be stacked one on top of another in order to efficiently utilize the interior volume of the container 12. A spring-loaded plunger 31 is disposed within the container 12 and is adapted to dispense the cargo straps 21 therefrom. The elongated container 12 further comprises a cutout 14 disposed along the length thereof. A lever 15 extends through the cutout 14 and is attached to the spring-loaded plunger 31. The lever 15 and cutout 14 configuration control the expansion of the spring-loaded plunger 31, wherein a user can move the lever 15 along the cutout 14 in order to dispense the cargo straps 21 from the elongated container 12.

The open upper end is removably covered by a door 13 that is pivotally secured thereto by a hinge 17. The door 13 is adapted to provide access to the cargo straps 21 disposed within the container 12 and prevent the cargo straps 21 from falling out thereof during transportation or when the container 12 is horizontally positioned, as shown in the illustrated embodiment. The door 13 is maintained in a closed position via a locking mechanism, such as a latch 16.

The cargo straps 21 are adapted to be inserted into the container 12 through the open upper end thereof, wherein the cargo straps 21 are dispensed therefrom via the spring-loaded plunger 31. The spring-loaded plunger 31 is disposed within the elongated container 12 and comprises a plate 22 and a spring 24, wherein the spring 24 includes a first end and a second end. In the illustrated embodiment, the first end of the spring 24 is secured to the base 27 of the container 12 by any suitable fastener, such as a screw. The second end of the spring 24 is adapted to collapse and expand between the open upper end and the base 27 of the container 12.

In some embodiments, a cap 25 is disposed over the second end of the spring 24, wherein the cap 25 comprises an open lower end, one or more sidewalls, an interior volume, and a top wall 37. Preferably, the cap 25 comprises a circular cross section in order to correspond with the cylindrical configuration of the spring 24 and elongated container 12. The second end of the spring 24 is disposed through the open lower end of the cap 25 and secured within the interior thereof. The cap 25 is adapted to protect the end of the spring 24 and prevent the end thereof from becoming caught on other components of the device 11, such as the plate 22. The upper surface of the top wall 37 of the cap 25 is planar in order to efficiently engage the surface of the plate 22 disposed next thereto. The cap 25 and plate 22 remain flush against one another due to the force applied by the spring 24 as the spring 24 is compressed. In some embodiments, however, the spring 24 is directly secured to the plate 22.

The plate 22 preferably comprises a circular cross section so as to correspond to the shape of the container 12. The plate 22 comprises a first side 32 and a second side 33, wherein the second side 33 engages with the top wall 37 of the cap 25. In some embodiments, the first side of the plate 22 is planar and adapted to receive rolled cargo straps 21 directly thereon.

In other embodiments, the device 11 comprises a spacer 23, wherein the first side 32 of the plate 22 is planar in order to remain flush against the surface of the spacer 23. The spacer 23 is positioned between the plate 22 and the open upper end of the elongate container 12 adapted to occupy space existing therebetween. When the plate 22 is disposed at the upper 34 end of the cutout 14, a space exists between the open upper end of the container 12 and the plate 22. If the space is too great, the cargo straps 21 remaining closest to the plate 22 cannot be dispensed from the container 12 by the spring-loaded plunger 31. In the illustrated embodiment, the spacer 23 comprises a cylindrical member having a first planar side in order to efficiently engage the plate 22 and a second planar side in order to receive a cargo strap 21 thereon. The spacer 23 and plate 22 are secured together by any suitable fastener, such as a screw. In some embodiments, the spacer 23 is integral to the plate 22.

The cutout 14 disposed on the sidewall 30 of the container 12 provides a track for the lever 15 to move therealong in order to control the spring-loaded plunger 31. The lever 15 comprises a first end adjustable secured to the plate 22 and a second end disposed through the cutout 14. In the illustrated embodiment, the cutout 14 comprises a plurality of catches 36 in order to prevent the lever 15 from moving towards the open upper end of the container 12, thereby preventing the spring 24 from automatically expanding. When storing the cargo straps 21, the rolled straps 21 are inserted into the upper end of the elongated container 12 wherein the user is applying pressure to the plate 22, thereby compressing the spring 24. Thus, the lever 15 automatically moves along the cutout 14 towards the base 27 of the container 12 because the lever 15 is connected to the plate 22. When a user no longer applies pressure to the plate 22, the catch 36 stops the lever 15 from moving, thereby preventing the spring 24 from expanding.

When dispensing the cargo straps 21, the lever 15 can be manually moved along the cutout 14. Once the user has dispensed the desired amount of cargo straps 21, the lever 15 is prevented from further movement as it becomes caught on a catch 36. The cutout 14 extends between the upper end and the base 27 of the container 12. A portion disposed between the catches36 is preferably the length of the width of a cargo strap 21, such that each movement of the lever 15 allows a single cargo strap 21 to be dispensed from the container 12.

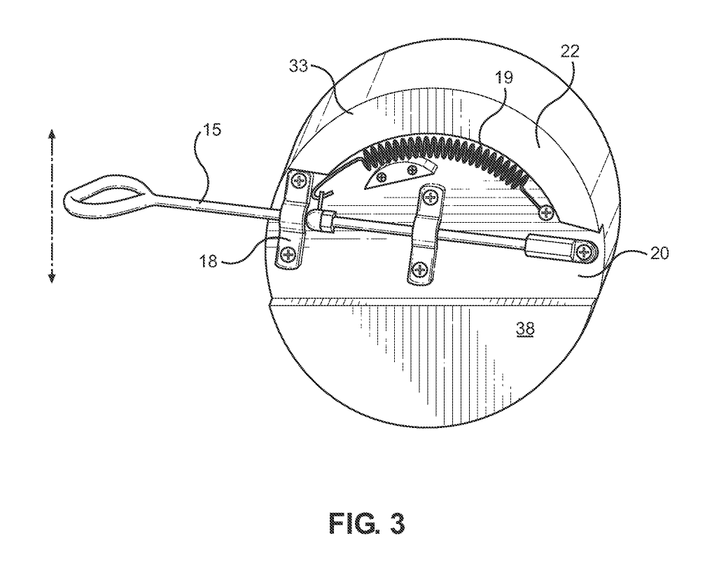

Referring now to FIG. 3, there is shown a perspective view of the second side of the plate of the cargo strap storing and dispensing device. In the illustrated embodiment, the second side of the plate 22 comprises a recessed area 20 wherein the lever 15 is pivotally secured thereto. The lever 15 extends outward from the plate 22 and comprises a spring mechanism adapted to allow the lever 15 to move from a starting configuration to over the catch, wherein the lever 15 automatically returns to the starting configuration when released. A lever spring 19 having a first end secured to the recessed area and a second end secured to the lever 15 allows the lever 15 to pivot and automatically return to the starting configuration, such that the lever 15 extends perpendicularly from the edge of the plate 22. The spring mechanism allows the lever 15 to automatically engage a catch when the cargo straps are inserted into the container 12, thereby preventing a user from manually having to lock or lift the lever 15 to engage a catch in order to prevent the spring-loaded plunger from automatically expanding. The elevated surface 38 of the second side 33 is planer so as to engage the cap of the spring. In some embodiments, the plate 22 is secured to the cap by any suitable fastener, such as a screw.

Referring now to FIG. 4, there is shown a cross sectional view of the cargo strap storing and dispensing device. In some embodiments, the interior of the elongated container 12 comprises a pair of guides 40 adapted to guide the spring-loaded plunger and the spacer 23 in order to prevent the plunger and spacer 23 from rotating moving along the length of the container 12. The guides 40 extend between the base of the container 12 and the open upper end thereof. In the illustrated embodiment, the guides 40 comprise an elongated rod having any suitable configuration, including a square, rectangular, or semi-circular cross section. Preferably, each guide 40 is disposed on opposing sides of the container 12.

The pair of guides 40 are adapted to engage with a pair of channels 41 disposed on the spring-loaded plunger and the spacer 23. Each channel 41 extends the length each component on which they are disposed. In the illustrated embodiment, a first channel 41 is disposed on an opposing side of a second channel 41. The first channel 41 aligns with a first guide 40 and the second channel 41 aligns with a second guide 40, wherein the channels 41 are adapted to receive the guides 40 therein. Thus, as the spring-loaded plunger and spacer 23 move within the elongated container 12, the channels 41 slide along the guides 40 in order to prevent the rotation thereof.

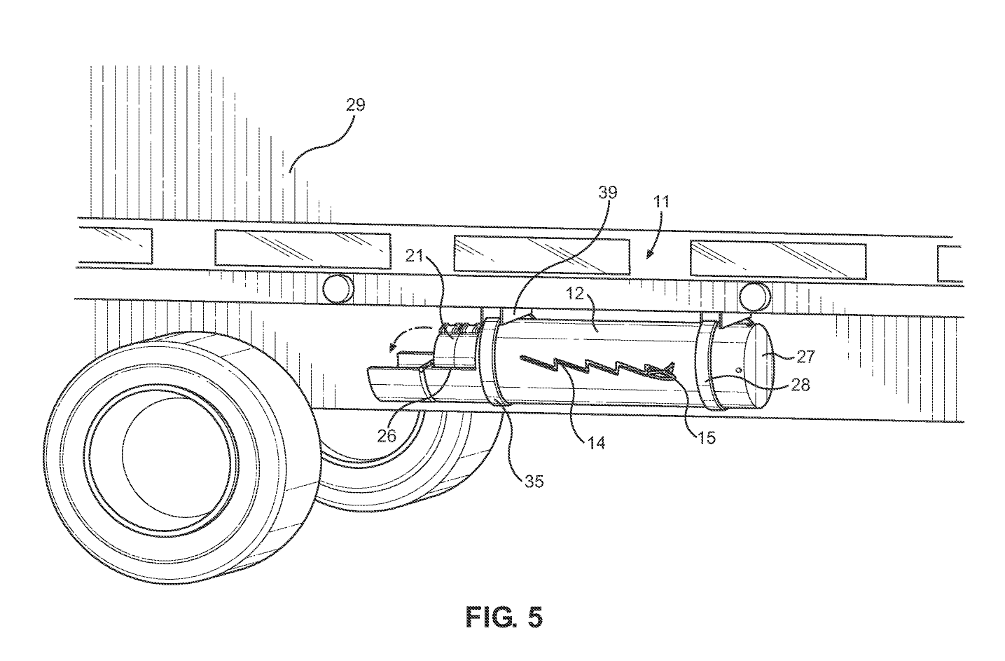

Referring now to FIG. 5, there is shown a perspective view of an embodiment of the cargo strap storing and dispensing device wherein the elongated container is secured to a vehicle. The elongated container 12 is adapted to be positioned on a vehicle 29 in order for the cargo straps 21 to remain accessible when transporting a load of material. The cargo strap storing and dispensing device 11 can be positioned horizontally, vertically, or any angle therebetween. In some embodiments, the device comprises one or more attachment mechanisms 28 adapted to secure the device to a vehicle 29. Any suitable attachment mechanism 28 can be used, including a bracket comprising a loop configuration 35 and a clamp 39, wherein the loop portion 35 of the bracket fits around the elongated container 12 and the clamp 39 is adapted to removably secure the attachment mechanism 28 to the vehicle 29. The clamp 39 can be secured to the vehicle by any suitable fastener, such as screws. The attachment mechanism 28 is integral with the elongated container 12.

In operation, a user pushes the lever 15 along the cutout 14. As the lever 15 is moved towards the open upper end 26 of the container 12, the spring expands, thereby pushing the cargo straps 21 towards the open upper end 26 and dispensing the straps 21 therefrom. To store the cargo straps 21, the user inserts the cargo straps 21 within the open upper end 26, thereby pushing the spring-loaded plunger towards the base 27 of the container 12. As the spring compresses, more space is created within the elongated container 12 to receive more cargo straps 21 therein.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A cargo strap storing and dispensing device, comprising:
an elongated container having a base, a sidewall, and an open upper end, defining an interior volume therein, wherein said elongated container is adapted to receive one or more cargo straps therein;
wherein said elongated container is cylindrical in configuration;
a spring-loaded plunger disposed in said interior volume of said elongated container, wherein said spring-loaded plunger comprises a plate and a spring adapted to dispense said one or more cargo straps from said open upper end of said elongated container.

2) The cargo strap storing and dispensing device of claim 1, wherein said spring comprising a first end secured to said base of said elongated container, wherein a second end of said spring is adapted to expand in order to push said plate towards said open upper end of said elongated container and compress in order to allow said one or more cargo straps to fit in said interior volume of said elongated container.

3) The cargo strap storing and dispensing device of claim 1, further comprising a lever having a first end and a second end, wherein said first end of said lever is adjustably secured to said plate and said second end of said lever is perpendicularly disposed through a cutout disposed on said sidewall of said elongated container, such that a user is able to manipulate said lever in order to move said plate towards said open upper end of said elongated container.

4) The cargo strap storing and dispensing device of claim 1, further comprising a door pivotally secured to said open upper end of said elongated container.

5) The cargo strap storing and dispensing device of claim 4, further comprising a locking mechanism disposed on said door in order to allow said door to remain in a closed position.

6) The cargo strap storing and dispensing device of claim 1, further comprising a cutout having a plurality of catches adapted to control an expansion of said spring.

7) The cargo strap storing and dispensing device of claim 3, wherein said cutout comprises a plurality of catches adapted to control an expansion of said spring.

8) The cargo strap storing and dispensing device of claim 6, wherein said cutout comprises a zigzag pattern.

9) The cargo strap storing and dispensing device of claim 1, further comprising a spacer comprising a cylindrical member, wherein said spacer is disposed within said interior of said elongated container and positioned between said open upper end of said elongated container and said plate.

10) The cargo strap storing and dispensing device of claim 1, further comprising a bracket having a loop configuration adapted to receive said elongated container therethrough and a clamp disposed on said bracket, wherein said clamp is adapted to removably secure said bracket to a vehicle.

11) The cargo strap storing and dispensing device of claim 3, wherein a side of said plate comprises a recessed area, wherein said first end of said lever is disposed within said recessed area and is pivotally secured thereto by a spring mechanism adapted to allow said lever to automatically engage a catch on said cutout.

12) The cargo strap storing and dispensing device of claim 11, further comprising a cap disposed over an end of said spring, wherein said cap comprises a top wall, one or more sidewalls, and an open lower end, such that said end of said spring is disposed through said open lower end of said cap and said top wall of said cap is adapted to engage with said plate in order to prevent said end of said spring from becoming disposed in said recessed area of said plate.

13) The cargo strap storing and dispensing device of claim 1, further comprising a pair of guides disposed along a length of an interior of said elongated container and a pair of channels disposed on said spring-loaded plunger, such that said pair of guides are disposed within said pair of channels and adapted to prevent said spring-loaded plunger from rotating while moving within said elongated container.
